(19) United States
(12) Patent Application Publication
(10) Pub. No.: US 2011/0181837 A1
(43) Pub. Date: Jul. 28, 2011

(54) METHOD AND SYSTEM FOR PRODUCING A PEPPER'S GHOST

(76) Inventors: Ian Christopher O'Connell, London (GB); Eiisabeth Berry, London (GB); Mark Hanna, London (GB)

(21) Appl. No.: 13/054,390

(22) PCT Filed: Jul. 14, 2009
(86) PCT No.: PCT/GB09/50855

§ 371 Date: Apr. 11, 2011

Related U.S. Application Data
(60) Provisional application No. 61/080,411, filed on Jul. 14, 2008.
(60) Provisional application No. 61/140,817, filed on Dec. 24, 2008.

(30) Foreign Application Priority Data
Jun. 12, 2009 (GB) 0910116.3
Jun. 12, 2009 (GB) 0910150.2

(51) Int. Cl. G03B 21/28; G03B 21/26; G02B 27/22

(52) U.S. Cl. 353/10; 353/28; 353/29; 353/30; 353/36; 353/50

(57) ABSTRACT

This invention concerns a method of producing a Pepper's Ghost. The method may comprise projecting an image of a subject onto a reflective and transparent screen (7) to create a virtual image (15) of the subject alongside an object (21). The subject of the virtual image may have a colour temperature and the method may comprise illuminating the object (21) with light having a colour and intensity that results in a colour temperature of the object (21) at least approximately matching the colour temperature of the subject of the virtual image. The method may comprise altering the intensity of light that falls on the object (21) by moving the lighting arrangement towards or away from the object (21) whilst maintaining an intensity of light omitted by the lighting arrangement constant. The method may comprise projecting patterns (53) and/or images that would be achieved if the subject was actually present and light was reflected or transmitted by the subject and/or creating a shadow which the subject in the virtual image would make if the subject was actually present. The method may comprise creating two virtual images using the same foil. The method may comprise projecting an image of the subject onto the screen (7) onto a reflective bounce screen (4) and altering a distance between the projector and the reflective bounce screen (4) to move the virtual image.

This invention relates to a method and system for producing a Pepper's Ghost, and in particular, but not exclusively a method and system of illuminating the location where a Pepper Ghost is projected.

A Pepper's Ghost is created by projecting an image onto a transparent and reflective screen placed at 45 degrees to a projector and an audience's eye line such that the audience perceives the image as a virtual image in front of a backdrop behind the screen. In this way it may be possible to film a person at a first location and produce a Pepper's Ghost of the person at a remote, second location such that the person appears to be present at the second location. This is known as “telepresence”. The Pepper's Ghost may be produced in the vicinity of a person actually present at the second location such that the person who is the subject of the Pepper's Ghost can appear with the person who is actually present.

It is common to light person(s) who are to be viewed alongside the Pepper's Ghost and also areas near to the Pepper's Ghost. However, it has been found that conventional lighting of the person(s) and areas near to the Pepper's Ghost can detract from the illusion that the subject of the Pepper's Ghost is actually present at the second location.

According to a first aspect of the invention there is provided a method of producing a Pepper's Ghost, the method comprising projecting an image of a subject onto a reflective and transparent screen to create a virtual image of the subject alongside an object, the subject in the virtual image having a colour temperature, and illuminating the object with light having a colour and intensity that results in a colour temperature of the object at least approximately matching the colour temperature of the subject in the virtual image.

It will be understood that the term “projecting” is not limited to generation of an image with a projector but includes generation of an image through any suitable display device and likewise the term “projector” includes any such display device. In one embodiment the projector could be an illuminated stage setup, illuminated such that the stage setup could be reflected off the reflective and transparent screen.

It will be understood that “the object” in any of the aspects of the invention could be a living entity such as a person or animal or “the object” could be a non-living entity such as a chair, a table or a hat stand.

It will be understood that the term “a colour temperature of the person at least approximately matching the colour temperature of the subject of the virtual image” means the colour temperature of the person is at least within 1000° Kelvin of the colour temperature of the subject, preferably at least within 500° Kelvin of the colour temperature of the subject and most preferably within 200° Kelvin of the colour temperature of the subject. For comparison, daylight at noon is typically 5500° Kelvin, tungsten lighting is typically 3000-3500° Kelvin and arc discharge lights are typically 6000-7000° Kelvin.

Where the object is a living entity, the colour temperature may be the colour temperature of the skin of the subject in the virtual image and the living entity.

According to a second aspect of the invention there is provided a method of producing a Pepper's Ghost, the method comprising projecting an image of a subject onto a reflective and transparent screen to create a virtual image of the subject alongside an object, the subject in the virtual image having a luminance, and illuminating the object with light having a colour and intensity that results in a luminance of the object at least approximately matching the luminance of the subject in the virtual image.

In one embodiment the subject in the virtual image has a colour temperature and luminance and illuminating the object comprises illuminating the object with light having a colour and intensity that results in a colour temperature and luminance of the object at least approximately matching the colour temperature and luminance of the subject in the virtual image.

An advantage of matching the colour temperature and/or the luminance of the subject in the virtual image with the object is that it may appear that the subject and the object are illuminated by the same light source; creating the illusion that the subject is actually present at the location the virtual image is located. Furthermore, by matching the colour temperature of light illuminating the object with the colour temperature of the subject in the virtual image, light spill into the virtual image location from the light illuminating the object may not be as detrimental to the illusion of realism of the subject in the virtual image as would be the case if the colours were not matched.

In one embodiment the colour temperature and luminance of the object and the colour temperature and luminance of the subject in the virtual image are colour temperatures and luminance as perceived directly by at least one viewer. In another embodiment, the colour temperature and luminance of the object and the colour temperature and luminance of the subject in the virtual image are colour temperatures and luminances as perceived by at least one viewer through a camera or on a film produced by the camera.

It will be understood that the terms “realism” and “real” when referring to the subject in the virtual image are to be interpreted in the sense that the subject appears to be actually present. The subject in the virtual image may be a real person who is not actually present at the location of the virtual image.

When filming the subject to be projected as part of the Pepper's Ghost, the subject may be illuminated with light. The directions from which the subject has been mostly strongly lit at the time of filming will be evident from the light observed on the subject when viewed as a virtual image by the at least one viewer. According to a third aspect of the invention there is provided a method of producing a Pepper's Ghost, the method comprising projecting an image, comprising a subject illuminated by a light from one or more directions, onto a reflective and transparent screen to create a virtual image of the subject for at least one viewer at a viewing location, and illuminating the object with a light source which at least approximately matches the one or more directions of the light source.

An advantage of matching the one or more directions of illumination of the subject is that the object and the subject in the virtual image appear to be illuminated by the same light source.

According to a fourth aspect of the invention there is provided a method of producing a Pepper's Ghost, the method comprising projecting an image of a subject onto a reflective and transparent screen to create a virtual image of the subject to be perceived alongside an object, illuminating the object with a lighting arrangement and altering an intensity of the light that falls on the object by moving the lighting arrangement towards or away from the object whilst maintaining an intensity of light emitted by the lighting arrangement constant.

One advantage of the fourth aspect of the invention is that the intensity of light that falls on the object can be altered without altering the power input to the lighting arrangement. In this way changes in the intensity of light falling on the subject can be achieved without changes in the colour emitted by the lighting arrangement occurring. The colour of light emitted by a lighting arrangement can occur if the intensity of light emitted by the lighting arrangement is changed by, for example, altering the power input to the lighting arrangement. Undesirable changes in the colour emitted by the lighting arrangement could result in changes in the colour temperature of the object, potentially impairing the illusion of realism with respect to the subject in the virtual image.

According to a fifth aspect of the invention there is provided a method of producing a Pepper's Ghost, the method comprising projecting an image of a subject onto a reflective and transparent screen to create a virtual image of the subject in front of a backdrop as perceived by at least one viewer at a specific viewing location, wherein an area of the backdrop to a side of the subject in the virtual image as perceived by the at least one viewer at the specific viewing location is illuminated at a higher intensity than the area behind the subject.

It will be understood that the term “an area of the backdrop to a side of the subject in the virtual image as perceived by the at least viewer at a specific viewing location” includes areas to the left, to the right and above the virtual image but does not include an area perceived by the at least one viewer at the specific viewing location directly behind the virtual image.

It is advantageous to illuminate an area of the backdrop to a side of the subject in the virtual image to a higher intensity than an area behind the virtual image as perceived by a viewer as light on the area behind the subject would pass through the subject, revealing that the subject is transparent and therefore not real. An advantage of illuminating an area of the backdrop to a side of the subject in the virtual image is that it may appear that the virtual image is blocking hypothetical light reflected by the backdrop. This creates the illusion that the subject in the virtual image is a solid body and therefore creates the illusion that the subject is actually present at the location of the virtual image.

In one embodiment the viewing location is a location which faces a side of the reflective and transparent screen from which the image of the subject is reflected. The viewing location may be within the width of the reflective and transparent screen.

In general, areas of the Pepper's Ghost other than the location of the object and the subject in the virtual image are illuminated with light of an intensity that results in a luminance of the areas which is lower than the luminance of the object and the subject in the virtual image. A brighter image appears more solid and real than a dimmer one. By illuminating areas around the subject in the virtual image with light of low intensity, by comparison a viewer may perceive the image to be brighter. In one embodiment the lighting arrangement illuminates an area on the backdrop to a side of the subject in the virtual image, on the floor below the virtual image, on a wall to the side of the subject in the virtual image, on a ceiling above the virtual image and/or on a viewer location with light of an intensity that results in a luminance of the areas which is lower than the luminance of the object and the subject in the virtual image.

In one embodiment the lighting arrangement illuminates an area on the backdrop to a side of the subject in the virtual image, on the floor below the virtual image, on a wall to the side of the subject in the virtual image, on a ceiling above the virtual image and/or on a viewer location with light emitted at an intensity, wherein the intensity of the light that falls on the area is altered by moving the lighting arrangement towards or away from the area. In this way the intensity of light incident on these areas may be altered while a power input to the lighting arrangement and therefore the colour output of the lighting arrangement remains constant. It may be advantageous to be able to alter the intensity without affecting the colour so that a viewer does not notice that a reduced intensity is being used to create the illusion.

In some embodiments the light output characteristics of the lighting arrangement are controlled substantially in real time, wherein the lights illuminating the object and/or the area of the backdrop to a side of the subject in the virtual image at the perceived location are controlled in response to changes in the perceived location of the subject in the virtual image.

According to a sixth aspect of the invention there is provided a method of producing a Pepper's Ghost, the method comprising projecting an image, comprising a subject illuminated by a light, onto a reflective and transparent screen to create a virtual image of the subject at a location as perceived by at least one viewer, and illuminating an area around the subject with light from a lighting arrangement. An advantage of this is that lighting an area around the virtual image of the subject is that it may enhance the three dimensional appearance of the virtual image as perceived by at least one viewer at a specific viewing location.

In one embodiment the lighting arrangement located at least approximately at the location of the virtual image illuminates an area to a side of the subject in the virtual image as perceived by the at least one viewer at the specific viewing location. It will be understood that the term “an area to a side of the subject in the virtual image as perceived by the at least one viewer at the specific viewing location” includes areas to the left, to the right and above the virtual image but does not include an area perceived by the at least one viewer at the specific viewing location directly behind the virtual image. This ensures that the at least one viewer at the specific viewing location does not observe light passing through the subject in the virtual image, which may compromise the realism of the virtual image.

In one embodiment the lighting arrangement is located at least approximately at the location of the virtual image. It will be understood that the term “a lighting arrangement is located at least approximately at the location of the virtual image of the subject” means that the lighting arrangement is no more than 3 metres away from the virtual image, or preferably no more the 1.5 meters away from the virtual image.

In one embodiment the image of the subject comprises a dominant colour and the lighting arrangement illuminates an area to a side of the subject in the virtual image with light having the same or similar colour to the dominant. For example, if the subject is wearing a pale blue dress, then the colour of light illuminating an area to the side of the subject is of the same or similar pale blue.

An advantage of matching the colour temperature and emitted light direction at the location of the subject with that in the image is that the illumination of the area to a side subject is consistent with that in the image.

According to a seventh aspect of the invention there is provided a method of producing a Pepper's Ghost, the method comprising projecting an image, comprising a subject illuminated by a light, onto a reflective and transparent screen to create a virtual image of the subject for at least one viewer at a viewing location, and a light source located to be visible to the at least one viewer at the viewing location and appear to the at least one viewer to provide the light present in the image. An advantage of this is that the at least one viewer may believe that the subject in the virtual image is really illuminated by the light source and therefore is actually present.

In one embodiment the light provided by light source has a low intensity. For example, the intensity of the light provided by the light source may be inconsequential compared with the intensity of light present in the virtual image of the subject. This has the advantage that the light from the light source does not compromise the solidity and therefore the reality of the virtual image. In one embodiment, the method comprisese providing a filter to block light emitted from the light source. In this way the light emitted by a bright light source does not compromise the appearance of solidity of the subject in the virtual image but creates the illusion that the light in the image is generated from the light source.

According to eighth aspect of the invention there is provided a method of producing a Pepper's Ghost, the method comprising producing a production in proximity to a reflective and transparent screen for at least one viewer at a viewing location, wherein the at least one viewer at the viewing location is illuminated by a lighting arrangement and filmed by a camera to create an image of the at least one viewer, the method further comprising projecting the image of the at least one viewer onto the reflective and transparent screen. In one embodiment the method comprises projecting an image of a subject (that is not the at least one viewer) onto a reflective and transparent screen to create a virtual image of the subject.

An advantage of projecting the image of the at least one viewer, such as an audience member, onto the reflective and transparent screen is that each member of the audience can view the at least one viewer as a Pepper's Ghost image if the at least one viewer cannot be observed directly by that member of the audience. This may be particularly advantageous for a question and answer session.

According to a ninth aspect of the invention there is provided a method of producing a Pepper's Ghost, the method comprising projecting an image of a subject onto a reflective and transparent screen to create a virtual image of the subject, and illuminating an area on a floor, wall, ceiling and/or backdrop such that the area comprises illumination that appears to be reflected, transmitted and/or produced by the subject in the virtual image.

Recreating effects that one would expect if the subject in the virtual image was actually present on stage gives the illusion that the subject in the virtual image is actually present.

The subject in the virtual image may comprise a light source and illuminating the area comprises illuminating the area such that the resultant light on the floor, wall and/or backdrop appears to be a consequence of the light source.

By illuminating an area to appear to be a consequence of the light source of the subject in the virtual image, the virtual image may appear more real. For example, if the subject were holding a torch, then illuminating an area near the virtual image with light which appears to be produced by the torch adds to the realism of the Pepper's Ghost.

The subject in the virtual image may comprise areas through which light would be transmitted to create a light pattern if the subject was present and illuminating the area comprises projecting patterns and/or images on the floor, walls, ceiling and/or backdrop which represent possible patterns and/or images that would be achieved if the subject was actually present and light was transmitted through the subject. For example, if the subject of the virtual image is a car with windows then the floor, walls and/or backdrop may be illuminated with a pattern which appears as if light has been transmitted through the windows.

The subject of the virtual image may comprise areas of which light would be reflected to create a light pattern if the subject was present and illuminating the area comprises projecting patterns and/or images on the floor, walls and/or backdrop which represent possible patterns and/or images that would be achieved if the subject was actually present and light was reflected by the subject if the subject was present. For example, the image of the subject may comprise a reflective object such as a mirror or some glass, and illuminating the area comprises illuminating the area such that light that falls on the floor, wall and/or backdrop recreates the light that would be reflected by the reflective object if the reflective object were present.

According to an tenth aspect of the invention there is provided a method of producing a Pepper's Ghost, the method comprising projecting an image of a subject onto a reflective and transparent screen to create a virtual image of the subject, and illuminating an area on a floor, wall and/or backdrop such that the area comprises illumination that appears to create a shadow which the subject in the virtual image would make if the subject was actually present. Recreating shadows that would be present if the subject were present adds to the illusion that the subject is present. In one embodiment darker colour light may illuminate the area on the floor, wall, ceiling and/or backdrop to create the shadow.

According to a eleventh aspect of the invention there is provided a method of producing a Pepper's Ghost, the method comprising projecting an image of a subject onto a reflective and transparent screen to create a virtual image of the subject and projecting at least one other image onto the reflective and transparent screen to create a virtual image of the at least one other image.

According to an twelfth aspect of the invention there is provided a system for producing a Pepper's Ghost, the system comprising a reflective and transparent screen, a projector for projecting an image of a subject onto the reflective and transparent screen to create a virtual image of the subject, and at least one other projector for projecting at least one other image onto the transparent and reflective screen to create a virtual image of the at least one other image.

An advantage of creating a virtual image(s) of at least one other image is that the virtual image(s) may appear to be present alongside the virtual image of the subject. The at least one other image may comprise patterns which are relevant to the subject in the virtual image. Adding patterns may create elements of a background scenery for the subject which reduces the amount of information required at the filming end so that costs may be reduced. It also helps to make the virtual image look more three dimensional and realistic because real elements may be added on stage that merge with the virtual image and help the virtual image blend in with the surrounding area. For example, the pattern may comprise some mottled green light such that a virtual image is created alongside the subject which looks like grass, or at least a theatrical representation of grass. In one embodiment the at least one other image may comprise some text relevant to the subject in the virtual image. For example if the subject in the virtual image is a singer or a band a virtual image of the singer/band logo may be created alongside the subject.

According to a thirteenth aspect of the invention there is provided a method of creating a Pepper's Ghost, the method comprising using a projector to project an image of a subject onto a reflective and transparent screen via a reflective bounce screen to create a virtual image and altering a distance between the projector and the reflective bounce screen to move the virtual image.

In this way the virtual image of the subject may be made to move closer or further away from an audience, which increase the stage space which is accessible to the virtual image.

According to a fourteenth aspect of the invention there is provided a system for producing a Pepper's Ghost, the system comprising a transparent and reflective screen, a reflective bounce screen, a projector for projecting an image of a subject onto the reflective and transparent screen via the reflective bounce screen to create a virtual image of the subject, wherein the reflective bounce screen is movable such that a distance between the projector and reflective bounce screen can be altered.

According to a fifteenth aspect of the invention there is provided a method of creating a Pepper's Ghost, the method comprising using a projector to project an image of a subject onto a reflective and transparent screen via a reflective bounce screen to create a virtual image and directing light from a further light source onto the bounce screen to provide desired illumination.

It will be understood that the “desired illumination” does not create the image of the subject in the virtual image. Using the bounce screen to create desired illumination has the advantage of produces additional lighting effects which may be physically impossible to achieve otherwise. The light reflected off the bounce screen may help blend the subject in the virtual image with the background.

In one embodiment, directing light from a further light source may create a virtual floor that blends with the actual floor and assists in minimising the appearance of the image floating above the floor.

According to a sixteenth aspect of the invention there is provided a system for producing a Pepper's Ghost, the system comprising a transparent and reflective screen, a reflective bounce screen, a projector for projecting an image of a subject onto the reflective and transparent screen via the reflective bounce screen to create a virtual image of the subject and a further light source for directing light onto the bounce screen.

It will be understood that according to all the aspects the virtual image could be created by the object and a real image is an image of the subject created by projecting the projected image through the reflective and transparent screen. According to seventeenth aspect of the invention there is provided a method of producing a Pepper's Ghost, the method comprising producing a virtual image and a real image, wherein the virtual image is created by reflection of one of an object and projected image of a subject onto a reflective and transparent screen and the real image is created by transmission through the reflective and transparent screen of the other one of the object and projected image of the subject, wherein the real image and virtual image appear to at least one viewer alongside each other.

It will be understood that colour temperature matching of the first aspect of the invention, luminance matching of the second aspect of the invention, direction matching of the third aspect, altering an intensity of the light that falls on the object by moving the lighting arrangement towards or away from the object whilst maintaining an intensity of light emitted by the lighting arrangement constant of the fourth aspect of the invention, illuminating an area of the backdrop to a side of the subject in the virtual image as perceived by the at least one viewer at the specific viewing location at a higher intensity than the area behind the subject of the fifth aspect, illuminating an area around the subject of the sixth aspect of the invention, using a light source located to be visible to the at least one viewer to appear to the at least one viewer to provide the light present in the image of the seventh aspect, projecting the image of the at least one viewer onto the reflective and transparent screen of the eighth aspect, illuminating an area on a floor, ceiling wall and/or backdrop such that the area comprises illumination that appears to be reflected, transmitted and/or produced by the subject in the virtual image of the ninth aspect, illuminating an area on a floor, wall, ceiling and/or backdrop such that the area comprises illumination that appears to create a shadow which the subject in the virtual image would make if the subject was actually present of the tenth aspect, projecting at least one other image onto the reflective and transparent screen to create a virtual image of the at least one other image of the eleventh aspect and projecting an image of a subject onto a reflective and transparent screen via a reflective bounce screen to create a real or virtual image and altering a distance between the projector and the reflective bounce screen to move the real or virtual image of the twelfth aspect could be used with the seventeenth aspect of the invention. Accordingly, it will be understood that the subject in the virtual image may be an image of the object rather than a subject of the projected image.

Embodiments of the invention will now be described, by example only, with reference to the accompanying drawings, in which:—

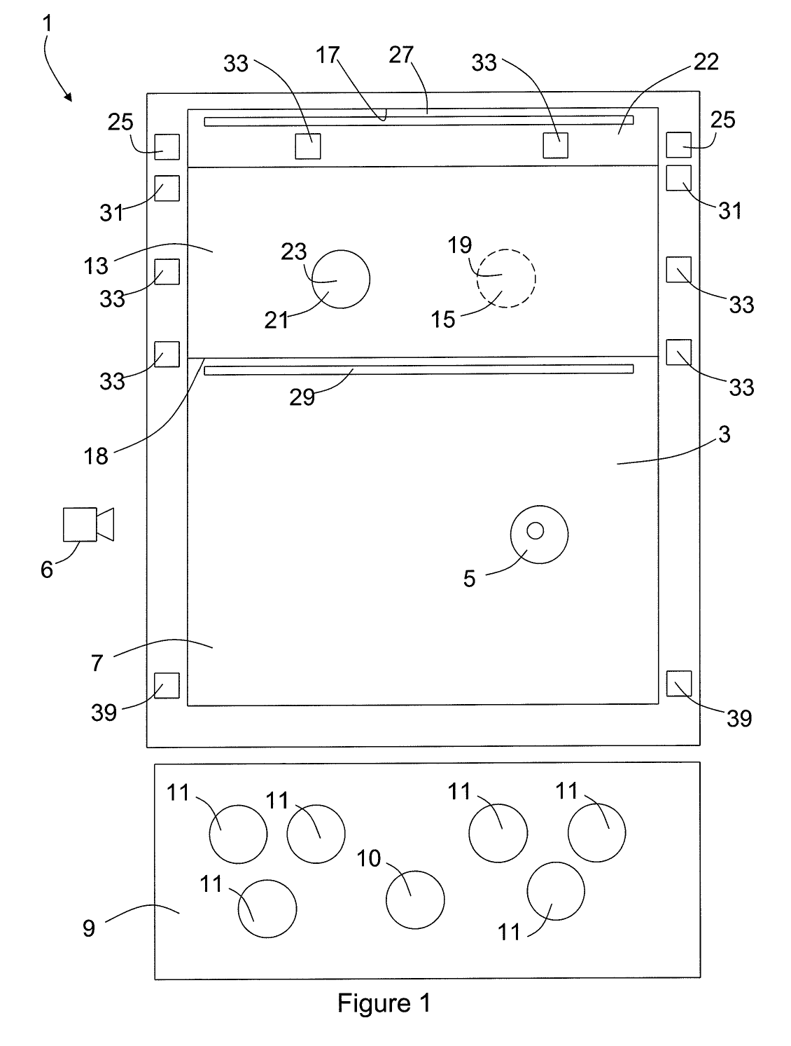

FIG. 1 is a schematic plan view of a Pepper's Ghost display in accordance with one embodiment of the invention;

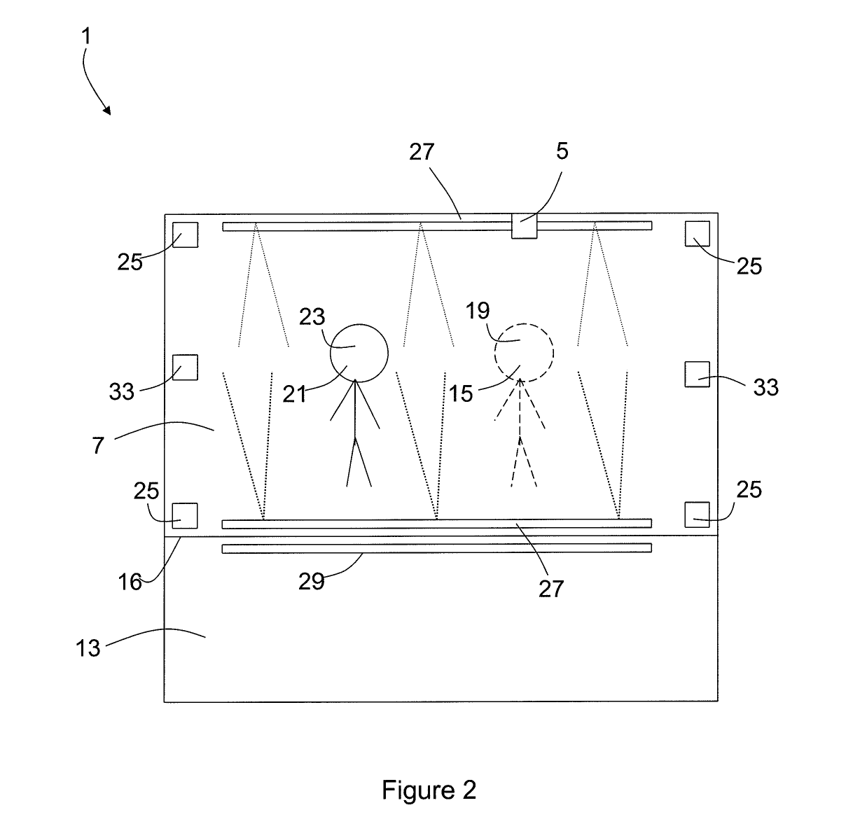

FIG. 2 is a front elevation view of the embodiment shown in FIG. 1.

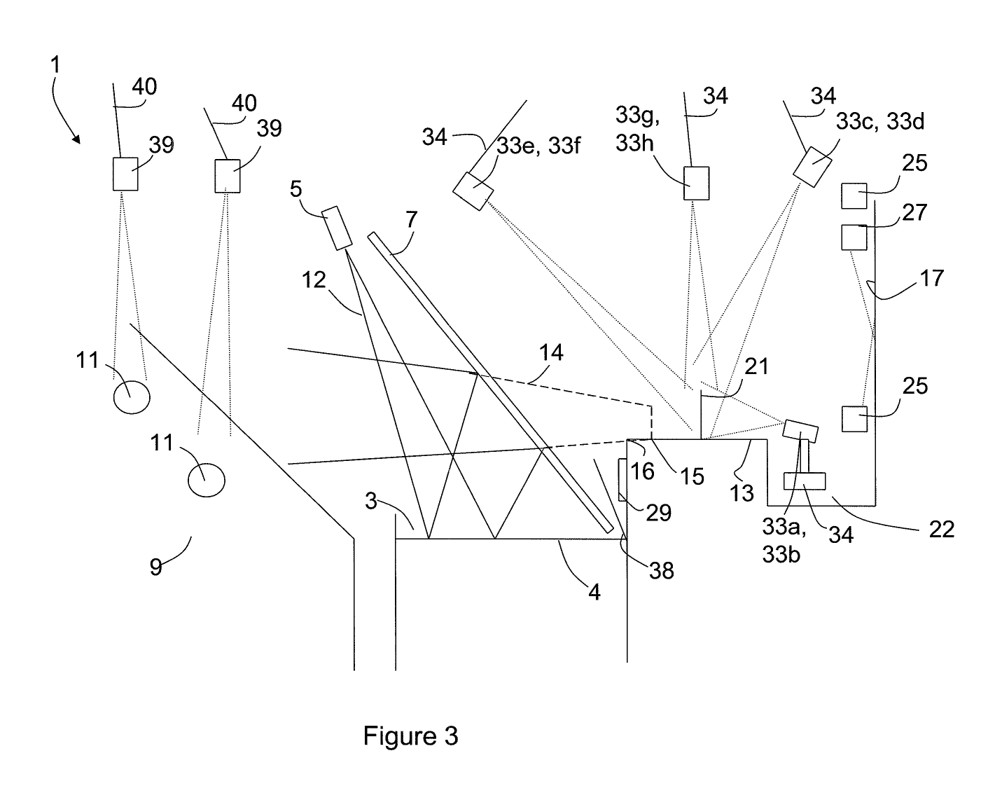

FIG. 3 is a side view of the embodiment shown in FIG. 1.

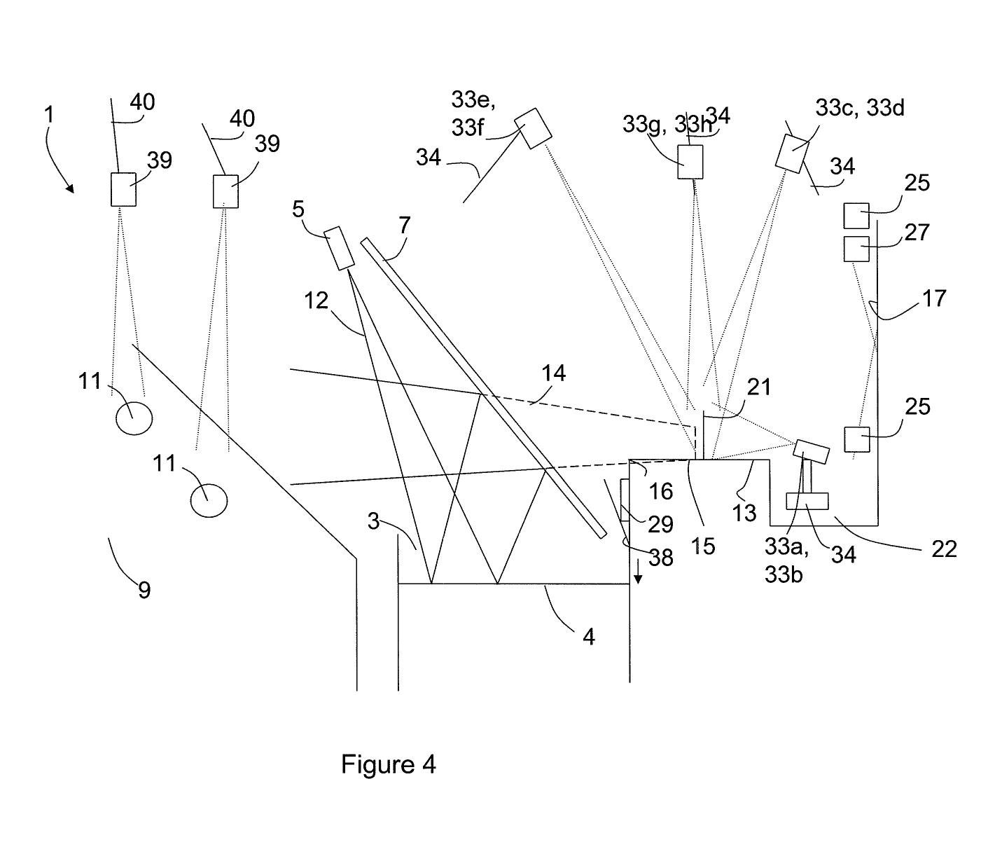

FIG. 4 is a side view of the embodiment shown in FIG. 1 to a side of the subject in 1, illustrating the effects of moving the bounce screen.

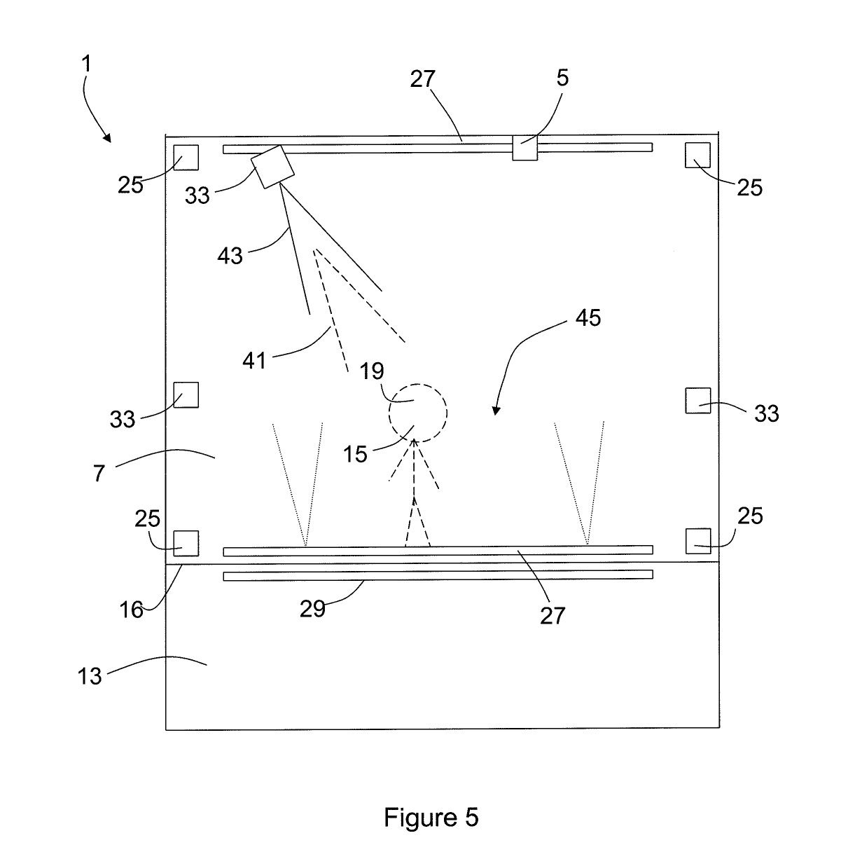

FIG. 5 is a front elevation view of another embodiment of the invention.

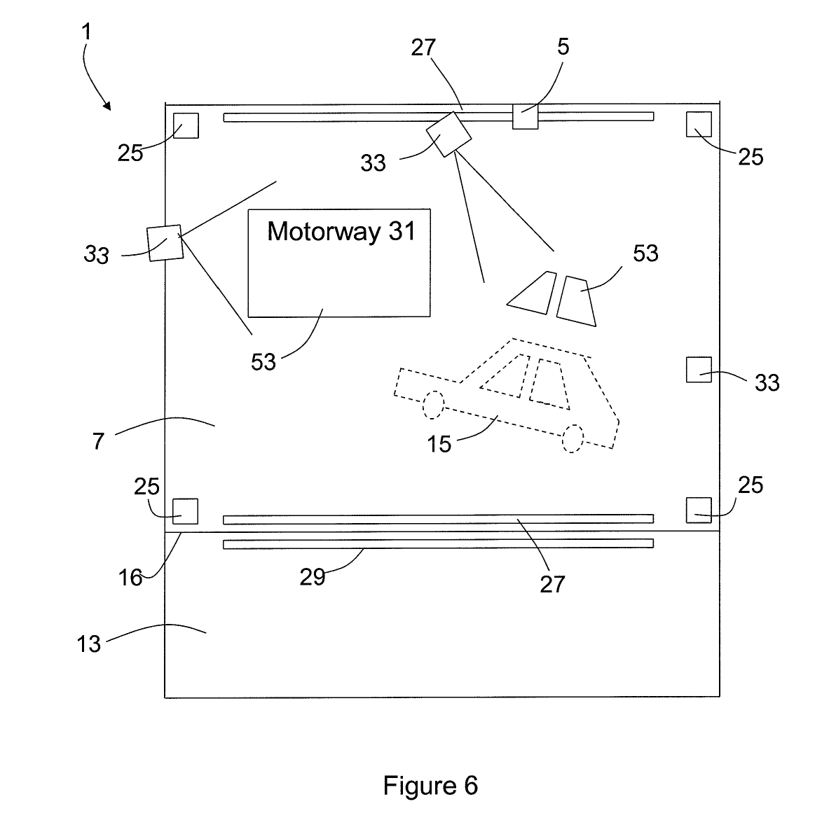

FIG. 6 is a front elevation view of another embodiment of the invention.

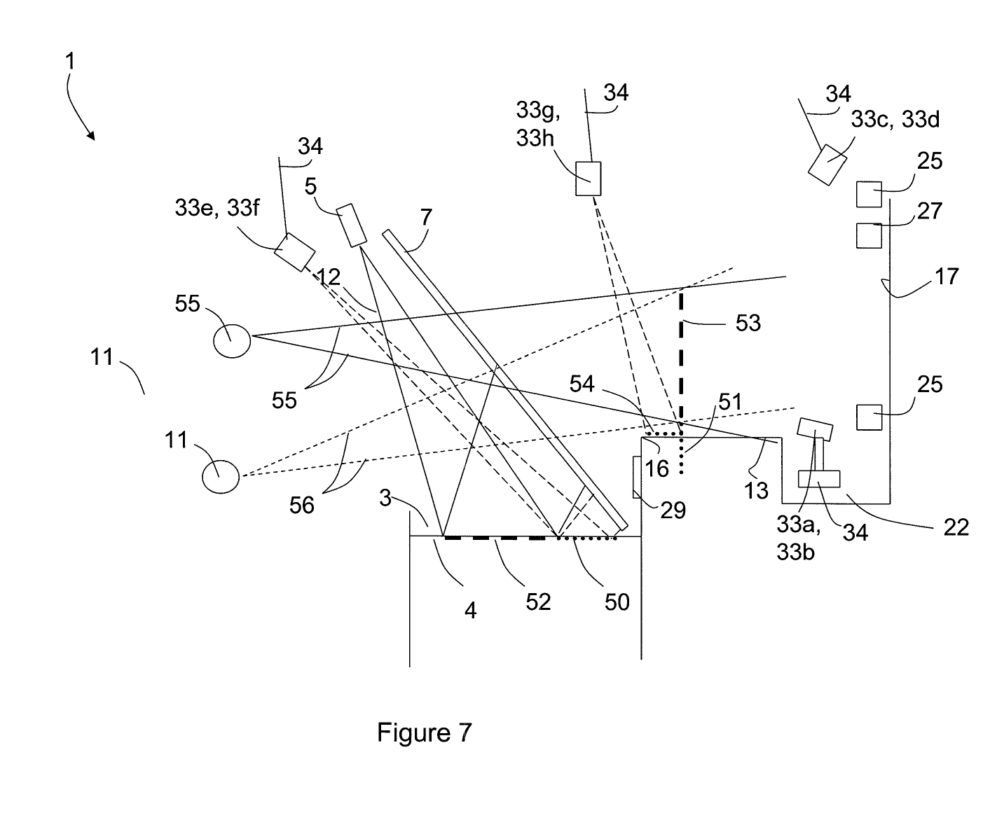

FIG. 7 is a side view of the embodiment shown in FIG. 1, including the bounce screen.

FIG. 1 shows a plan view of a Pepper's Ghost display 1. The Pepper's Ghost display 1 comprises a projection pit 3 for housing a bounce screen; a reflective and transparent screen 7 which extends over the top of the projection pit 3; a projector 5 located above the reflective and transparent screen 7; a viewing area 9 for housing viewers 11; a stage 13 on which a Pepper's Ghost 15 is perceived by the viewers 11; a backdrop 17 behind the Pepper's Ghost 15 relative to the viewers 11; and a lighting arrangement comprising a number of various types of lights for illuminating various areas of the Pepper's Ghost display 1.

The Pepper's Ghost 15, as perceived by the viewers 11, is created at a perceived location 19. The Pepper's Ghost 15 is a virtual image and is therefore represented by dashed lines. Relative to the viewers 11, the perceived location 19 of the Pepper's Ghost 15 is in front of the backdrop 17 and behind the transparent and reflective screen 7. The Pepper's Ghost 15 is usually created with a height of between 1.5 metres and 7.5 metres.

A person 21 is located at a location 23 of the stage 13 alongside the Pepper's Ghost 15. The person 21 is a real entity who is actually present at the location 23 and is therefore represented by solid lines. The person 21 may be located backwards, forwards, or to a side of the Pepper's Ghost 15 at a suitable distance from the Pepper's Ghost 15 so that the person 21 may be illuminated by lights of the lighting arrangement without incidental light falling on or around the Pepper's Ghost 15 in a way which is detrimental to the illusion that the Pepper's Ghost 15 is actually present at the perceived location 19. Alternatively, another living entity such as a monkey or a non-living entity such as a table may be located at the location 23 of the stage alongside the Pepper's Ghost 15.

The reflective and transparent screen 7 has a thin cubic shape with two large flat faces and four narrow side faces. The image of the subject in the Pepper's Ghost 15 is reflected by a large flat face of the reflective and transparent screen 7.

The viewing location 9 is located directly in front of and extends to the width of the large flat face of the reflective and transparent screen 7 which reflects the image of the subject in the Pepper's Ghost 15 such that the viewers 11 only have in their eye line the large flat face of the reflective and transparent screen 7 which reflects the image of the subject in the Pepper's Ghost 15. This prevents the viewers 11 being able to see any of the side faces of the reflective and transparent screen 7, which would be detrimental to the illusion of the Pepper's Ghost Display 1 as the viewers 11 would realise the Pepper's Ghost 15 was a virtual image created by the reflective and transparent screen 7.

A camera 6 is used to film the Pepper's Ghost display 1. The camera 6 is movable so that different areas of the Pepper's Ghost display 1 may be filmed, such as the location of Pepper's Ghost 15, the location of the person 21 or the viewing location 9. Alternatively the camera 6 may be positioned so that a panoramic view of the Pepper's Ghost display 1 may be filmed. A common problem when filming a Pepper's Ghost 15 in the presence of a person 21 is that the person 21 may appear over illuminated with the Pepper's Ghost 15 appearing much darker on film than to the naked eye. This may be overcome by using daylight filters on the camera 6. In another embodiment the camera 6 may be used to take photographs of the Pepper's Ghost display 1.

A programmer 10 is located in the viewing area 9 such that the programmer 10 has a clear and uninterrupted view of the stage 13.

The various lights are arranged to illuminate various areas of the Pepper's Ghost display 1 to enhance the realism of the Pepper's Ghost display 1. The intensity and colour of emitted light from a number of the lights in the lighting arrangement may be controlled remotely by the programmer 10. Also, the location of some of the lights and angle of illumination may also be controlled remotely by the programmer 10. A monitor is situated near to the programmer 10 which displays the different viewing angles that any of the viewers 11 or the camera 6 may have of the Pepper's Ghost display 1. This allows the programmer 10 to check that the lighting levels are consistent throughout the viewing angles of the Pepper's Ghost display 1. The programmer 10 also checks the focus of each of the lights in the lighting arrangement.

A lighting arrangement for a Pepper's Ghost display 1 is used to create scenery out of light to give the viewers 11 foreground and background references to help place the Pepper's Ghost 15 at the perceived location 19. A brighter Pepper's Ghost image looks more solid and is more visible to an audience and therefore appears more real than a dim image. To make the Pepper's Ghost appear brighter, overall lighting levels are kept low so that a high contrast between the Pepper's Ghost 15 and the surrounding area is created. This also helps to reduce the visibility of surface imperfections present on the reflective and transparent screen 7. Dim lighting is achieved by using many small, low power lights rather than fewer, brighter units.

Single unit lights 25 are located at top and bottom corners of the stage backdrop 17. The single unit lights 25 help to define edges of a black box frame in which the Pepper's Ghost 15 is located. The single unit lights 25 may be Robe ColorWash 575 AT wash lights.

In front of the backdrop 17 behind the stage 13 there is a backstage pit 22 for housing lights. Moving washlights 27 are located in the backstage pit 22 and above the backdrop 17 to uplight and downlight the backdrop 17 respectively. The moving washlights 27 may be for example Robe wash 236 LED washes. The backstage pit 22 prevents unwanted light spilling into areas of the stage 13 where illumination may be detrimental to the realism of the illusion, for example, in an area directly behind the Pepper's Ghost 15 relative to the viewers 11. Strip lights 29 are located at the stage front 18 to illuminate vertical surfaces such as the front of the stage 13. The strip lights 29 may be for example Scnick Scnack System's colour changing LED strip lights.

The embodiment as described includes the use of low power consumption LED “environmentally green” lighting instruments. These low profile instruments are highly efficient and offer a number of advantages over conventional tungsten lighting. LEDs consume far less power than incandescent lamps, allowing some LEDs to run off battery power, and tend to have less of a colour shift (i.e. the colour of the light emitted by the LEDs does not substantially change with changes in brightness). Furthermore, the cooler operating temperature of LEDs negates any need for air conditioning and is less of a fire risk. Accordingly, the method may comprise not providing air conditioning to cool the lighting arrangement. The use of LEDs is advantageous because LEDs are capable of being switched faster than conventional incandescent lamps and can be cycled at high frequency. In some embodiments the LEDs can be dimmed using pulse-width-modulation (PWM) or lowering of the forward current of the diodes.

Static LED lights 31 located to a side of the stage 13 are used to illuminate the side walls of the stage 13. Suitable lights for the static LED lights 31 are Robe ARC P144F lights.

Stage lights 33a and b are located in the upstage pit 22, above the backdrop 17, alongside the stage 13 and between the viewing area 9 and the stage 13. These are used to provide further lighting on the walls and ceiling of the stage, backlighting to the real person 21 on stage, and also provide effect lighting directly on the reflective and transparent screen 7 by means of combinations of colours and gobo pattern templates which may be a feature of the lighting fixture, which can be used to complement the virtual image and stage surroundings and enhance both the dimensionality of the image and the impression of the whole scene being real and continuous. Robe spot AT575 lights are an example of a suitable lighting fixture for this purpose

The Pepper's Ghost 15 has a luminance and colour temperature. The stagelights 33e and 33f are arranged to illuminate the person 21 so that it appears that the person 21 and the Pepper's Ghost 15 are illuminated by the same light source. This is achieved by arranging the stagelights 33e and 33f to illuminate the person 21 with light emitted at an intensity and colour so that the person 21 has a luminance and colour temperature which is the same as that of the Pepper's Ghost 15. The Pepper's Ghost 15 also appears to be illuminated from a particular direction. The stagelights 33e and 33f are therefore also arranged to illuminate the person 21 with light from a similar direction as that which appears to light the subject of the Pepper's Ghost effect. The matching of the colour temperature, intensity and the apparent direction of the light source between the virtual subject and the person 21 when viewed by the audience, or if the scenario is to be filmed, when viewed through the camera, is particularly important.

This is difficult to do without the spill causing the virtual image to become transparent, so some compromises may be needed on the position and intensity of stagelight 33e.

In some circumstances, the person 21 and the Pepper's Ghost 15 may be the same person, in which luminance and colour temperature matching is especially important. Skin tones may affect the luminance and colour temperature of an image or person. Therefore the feature lights are arranged to illuminate the person 21 so that the skin tones of the person 21 are the same as the Pepper's Ghost 15. Skin tones may be affected by a subject's natural colouring, any makeup applied to the subject's skin and/or the lighting used for illuminating the subject, as well as the set up of the lighting and recording equipment when the subject was filmed and the settings and characteristics of the video projector on the stage.

The stagelights 33c and 33d are arranged to backlight the stage. They will be arranged so that they match the backlight seen in the Pepper's Ghost 15 for colour temperature and intensity, and they seem to come from the same direction as the backlights on Pepper's Ghost 15, such that it would be possible that they were in actual fact responsible for the backlighting on Peppers Ghosts 15. They may be used to provide backlight for the person 21, or they may light the walls or floor of the stage 13. They may be either visible or hidden from the audience view, such that the audience may or may not be able to see whether or not the lamp is lit. If they are in view of the audience, they may be lit at a very low level with or without frost or diffusion filters to appear to be lighting the stage, but in actual fact not be outputting at a significant level.

The stage lights 33a to 33f are movable such that the distance between the stage lights 33a to 33f and the person 21 may be altered. By moving stage lights 33a to 33f closer or further away from the person the intensity of light and therefore the luminance of the person 21 may be increased or decreased respectively without having to vary the power input to the light, which can alter the colour output. This is particularly useful if for any reason the luminance of the Pepper's Ghost 15 changes while the colour temperature remains constant.

The stage lights 33a to 33f may also be used to illuminate other areas of the stage 13, side wall or backdrop 17. The intensity of light on these areas may be altered by changing the distance between the stage lights 33a to 33f and these areas. For example, the distance between the feature lights 33a to 33f and an area of the backdrop 17 near to the Pepper's Ghost may be increased to reduce the luminance of the area of the backdrop 17 near to the Pepper's Ghost 15 in order to create a high contrast between the Pepper's Ghost 15 and the area of the backdrop near to the Pepper's Ghost 15.

The feature stage lights 33a to 33f are also movable so that the angle of illumination between the stage lights 33a to 33f and the person 21 may be altered. The angle of illumination of the person 21 may need altering to match the apparent angle of illumination of the Pepper's Ghost 15.

Alternatively, non-movable stage lights 33a to 33f may be used which are cheaper. In this case the intensity of the light emitted by the stage lights 33a to 33f may be altered by changing the power input and the angle of illumination may be changed by moving the lights manually.

The stage lights 33a to 33f have an integrated colour mixing system for altering the colour emitted to match the colour temperature of the person 21 with that of the Pepper's Ghost 15. The colour mixing system uses cyan, magenta, and yellow to alter the emitted colour. The colour mixing system may also be used to create a high contrast between the Pepper's Ghost 15 and an area near to the Pepper's Ghost 15. For example, by illuminating an area of the backdrop 17 near to the Pepper's Ghost 15 with darker colours such as saturated deep blues a high contrast may be achieved. The colour of the stage lights 33a to 33f may be altered remotely at a control desk by the programmer 10. Suitable stage lights 33a to 33f are Robe 575 AT washlights

Alternatively, stage lights 33a to 33f with no colour mechanism may be used. These are cheaper. In this case the colour output of stage lights 33a to 33f may be altered manually by applying appropriately coloured gel. In the case where the stage lights 33a to 33f are tungsten lamps, the colour is altered using a blue coloured gel, for example Lee 200.

Stage lights 33a to 33f may have shutters, zooms and irises to create thinner and more controllable beams of light for preventing light spilling onto unwanted areas of the Pepper's Ghost display 1, such as the reflective and transparent screen 7, the bounce screen or the perceived location 19 of the Pepper's Ghost 15. Trusses, borders and other forms of concealment may be used to hide the various lights from the viewers 11.

FIG. 2 shows a front elevation view of FIG. 1 as viewed by the viewers 11 in the viewing area 9. Stage lights 33a and b are located in the upstage pit 22 and are therefore below the level of the stage floor.

FIG. 3 shows a side view of the embodiment shown in FIG. 1 and in particular the relative positions of the projector 5, bounce screen 4 and the reflective and transparent screen 7. The projector 5 projects an image of a subject onto the bounce screen 4. The bounce screen 4 is positioned such that the image from the projector 5 is reflected by the bounce screen 4 onto the reflective and transparent screen 7. The reflective and transparent screen 7 is set at an angle of 45 degrees to the projection pit 3 such that the image is reflected towards the viewing area 9. This creates a Pepper's Ghost 15 at a perceived location 19. The solid lines 12 in FIG. 3 represent real light rays which are projected by the projector 5 and reflected by the bounce screen 4 and the reflective and transparent screen 7. The dashed lines 14 represent virtual light rays as perceived by the viewers 11.

The light rays emanating from stage lights 33a to 33h are represented by dotted lines. Stage lights 33a to 33h are attached to holding frames 34 and are connected to the holding frames 34 such that the stage lights 33a to 33h may be moved to different positions to alter the distance and/or to alter the angle between the stage lights 33a to 33h and the person 21.

Shielding blocks 38 are positioned to block light from the strip lights 29 from spilling onto the reflective and transparent screen 7.

The audience lights 39 are suspended above the viewers 11 in front of and behind the viewers 11 relative to the stage 13. The audience lights 39 may highlight individual viewers. This is particularly advantageous if the Pepper's Ghost display 1 is being filmed, so that the Pepper's Ghost 15 and the highlighted viewer are both visible on the film. Movable spotlights may be suspended from frames 40 in order to achieve this effect. The audience lights 39 are adjustable in regards to intensity and colour to alter the luminance of the viewers 11. For example, just the appearance of anonymous viewers in a full auditorium may be required which may be achieved with low intensity, dark coloured wash lights. Alternatively, the viewers 11 may be illuminated to a high level using high intensity, bright colour audience lights 39.

The bounce screen 4 is movable such that the distance between the projector 5 and the bounce screen 4 may be altered, which subsequently alters the perceived location 19 of the Pepper's Ghost 15 on the stage 13. Moving the bounce screen 4 further away from the projector 5 moves the Pepper's Ghost 15 to a perceived location 19 further away from the viewers 11. This is shown in FIG. 4 where the bounce screen 4 has been moved further away from the projector relative to FIG. 3. Alternatively, moving the bounce screen 4 towards the projector 5 moves the Pepper's Ghost 15 to a perceived location closer to the viewers 11. For example, if the bounce screen is located 6 meters from the projector 5 (1 meter below the stage level 16) the perceived location 19 of the Pepper's Ghost 15 is 6 meters from the viewing area 9. By moving the bounce screen 4 down so that the distance between the projector 5 and the bounce screen is 7 meters (or 2 meters below the stage level 16) the Pepper's Ghost 15 moves back so that it is 7 meters from the viewing area 9. In this way the Pepper's ghost 15 may be made to move closer or further away from the viewers 11, which may increase the stage space available to a director.

The movement of the Pepper's Ghost 15 may cause the apparent luminance, colour temperature and angle of illumination of the Pepper's Ghost to alter. Therefore the feature lights 33 may need to be altered accordingly to maintain an illumination on the person 21 that matches the Pepper's Ghost 15.

To avoid light rays from the feature lights 33 passing through the Pepper's Ghost 15, the feature lights 33 are moved such that the light rays illuminate the Pepper's Ghost 15 at an angle in which the light rays do not pass through the Pepper's Ghost 15. For example the angle of illumination of the person 21 from the feature lights 33 may be altered from 45 degrees to the stage floor to 80 degrees to the stage floor.

It will be understood that modifications and alterations can be made to the described embodiments without departing from the invention as described herein. In another embodiment another living entity may appear alongside the Pepper's Ghost 15 and the feature lights 33 may be arranged to illuminate the living entity. For example an animal such as a cat may appear alongside the Pepper's Ghost 15.

Floor lights may illuminate parts of the stage 13 floor to define a plane that the Pepper's Ghost 15 appears to walk on, where giving a good base to the image improves the realism of the illusion. The floor lights should be dim to avoid light spill through the image. The floor lights would normally be located above the stage floor so that light from the floor lights may be directed to areas of the stage floor. Also ceiling lights to illuminate parts of the ceiling above the stage may be used. The ceiling lights are usually located on the stage floor and may add to the feeling of depth.

FIG. 5 shows an embodiment wherein the Pepper's Ghost 15 further comprises an image of a light source 41 illuminating the Pepper's Ghost 15, wherein the image of the light source is represented by dashed lines. For example, the subject of the Pepper's Ghost may be illuminated by a torch. In order to increase the reality of the illusion, the image of the light source 41 illuminating the Pepper's Ghost 15 is re-created by feature light 33, which emits light rays 43 represented by solid lines. The real lighting 43 gives the image of the light source 43 a more solid perception. The colour of the image of the light source 41 is matched by the feature light 33. This makes the two light sources appear more consistent and also reduce detrimental effects of light from the feature lights 33 passing through the Pepper's Ghost 15.

A further lighting effect which adds to the realism of the illusion is having the lighting arrangement arranged to illuminate an area around the Pepper's Ghost 15 that creates a lighting effect which appears to be a consequence of the image of the light source 41 illuminating the Pepper's Ghost 15. This is shown in FIG. 5, where illumination of an area 45 behind the Pepper's Ghost 15 relative to the image of the light source 41 purposely avoided by the LED washlights 27. This creates an illusion of a shadow effect which would be cast by the Pepper's Ghost 15 if the image of the light source were incident on the Pepper's Ghost 15.

The lighting arrangement may also be arranged to project patterns and images relating to the image around the Pepper's Ghost 15. This is shown in FIG. 6, where the Pepper's Ghost image 15 is a virtual image of a car. The feature lights 33 illuminate an area of the backdrop 17 with a pattern 53 that resembles a light pattern that would be created if the Pepper's Ghost 15 was actually present and light was shone on the Pepper's Ghost image 15. In this case the pattern 53 resembles the shape of the car windows. The feature lights may also illuminate the Pepper's Ghost display with patterns and images to add detail which increases the reality of the illusion. This is shown in FIG. 6, where feature lights 33 projects an image of a road sign with writing onto an area of the backdrop 17. Alternatively, a virtual image of the road sign may be created by projecting the image of the road sign onto the reflective and transparent screen 7.

To create the patterns and images the stage lights 33a to 33h may have built in gobo patterns. It will be understood that the word “gobo” is thought to have originated from an abbreviation of “GOes Between Optics”. A gobo comprises a mask or stencil of a pattern which is placed between the light source and outlet of the light and causes the pattern of the mask or stencil to be projected. The Robe ColorSpot 575 light may be used, which has a number of fixed and rotating gobo pattern choices. The rotating gobos can be programmed to rotate at various speeds and can be programmed to have specific orientations at specific times. The gobos are typically pressed out of metal or created on glass. Glass gobo are advantageous as more complex patterns may be created with further options of adding texture and colour available. Some lights have varying focus so that the gobo pattern may appear blurred or in focus depending which of these options add the most to the realism of the illusion.

In another embodiment, one of the stage lights 33a to 33h may be arranged to project light containing patterns and images directly onto the surface of the reflective and transparent screen 7 or onto the bounce screen 4, where such projections create a virtual image of the pattern or image which appears behind the reflective and transparent screen 7. For example, a virtual image of the road sign 53 may be created by projecting the image of the road sign onto the reflective and transparent screen 7. This can be an interesting effect to the viewers 11 as the pattern or image may appear to have come from out of nowhere. Many small projections could be used to project a number of virtual logos, designs or other images onto the stage 13 via the bounce screen 4 and reflective and transparent screen 7. Placing many small projections onto any point of the bounce screen 4 allows many low intensity lights to be used to illuminate the stage 13. The smaller projection may be moved around the stage 13 and/or could contribute to different elements of the display. This technique could be used to add virtual scenic elements around the Pepper's Ghost 15 to enhance the realism of the illusion. For example, virtual images such as office furniture, houseplants, trees, lamp posts, etc, may be added.

FIG. 7 shows that lights 33e and 33f may be used to project lighting effect 50 directly onto the bounce screen 4 below the image 52 on the bounce screen projected by projector 5. Virtual subject 53 is created by the reflection of the image 52 in the reflective and transparent screen 7. Lighting effect 50 is used to create the appearance of a shiny floor below the projected image 52, which is also reflected in the bounce screen so the floor effect appears as a virtual floor effect 51 below the virtual image 53. This blends in with a similar lighting effect 54 created by stage lights 33g and 33h that are used to confuse the viewers 11 and 55 as to where the actual floor is. A viewer 55 seated higher up than viewer 11 would normally see the feet of a virtual subject on the stage, because his sightline 56 perceives the feet of the image with a part of the stage as a background, but the viewer 11 would perceive that the image floats above the stage, because his view of the feet of virtual image 53 does not have the floor as a background. The virtual floor under the image means that the image does not appear to float because it seems to have a floor under its feet in accordance with the actual appearance on the stage floor. Furthermore because the lighting effect 51 is perceived to extend below stage level 16, and because a simple lighting effect does not have any particular horizontal or vertical orientation to the eye, the effect appears to fill the gap between the front of the stage 13 and the foil, apparently extending the floor to cover the edge of the bounce pit 4.

1. A method of producing a Pepper's Ghost, the method comprising projecting an image of a subject onto a reflective and transparent screen to create a virtual image of the subject alongside an object, the subject in the virtual image having a colour temperature, and illuminating the object with light having a colour and intensity that results in a colour temperature of the object at least approximately matching the colour temperature of the subject in the virtual image.

2. A method according to claim 1 wherein the subject in the virtual image has a luminance and illuminating the object comprises illuminating the object with light having a colour and intensity that results in a luminance of the object at least approximately matching the luminance of the subject in the virtual image.

3. A method of producing a Pepper's Ghost, the method comprising projecting an image of a subject onto a reflective and transparent screen to create a virtual image of the subject alongside an object, the subject in the virtual image having a luminance, and illuminating the object with light having a colour and intensity that results in a luminance of the object at least approximately matching the luminance of the subject in the virtual image.

4. A method according to claim 3 wherein the subject in the virtual image has a colour temperature and illuminating the object comprises illuminating the object with light having a colour and intensity that results in a colour temperature of the object at least approximately matching the colour temperature of the subject in the virtual image.

5. A method according to claim 1, wherein the object is a living entity such as a person or animal and the colour temperature is the colour temperature of the skin of the subject in the virtual image and the living entity.

6. A method according to claim 2 wherein the intensity of the light that falls on the object is altered by moving the lighting arrangement towards or away from the object whilst maintaining an intensity of light emitted by the lighting arrangement constant.

7. A method of producing a Pepper's Ghost, the method comprising projecting an image of a subject onto a reflective and transparent screen to create a virtual image of the subject to be perceived alongside an object, illuminating the object with a lighting arrangement and altering an intensity of the light that falls on the object by moving the lighting arrangement towards or away from the object whilst maintaining an intensity of light emitted by the lighting arrangement constant.

8. A method according to claim 1 wherein the subject in the virtual image has an angle of illumination and illuminating the object comprises illuminating the object with light having an angle of illumination at least approximately matching the angle of illumination of the subject in the virtual image.

9. A method of producing a Pepper's Ghost, the method comprising projecting an image of a subject onto a reflective and transparent screen to create a virtual image of the subject in front of a backdrop as perceived by at least one viewer at a specific viewing location, wherein an area of the backdrop to a side of the subject in the virtual image as perceived by the at least one viewer at the specific viewing location is illuminated at a higher intensity than the area behind the subject.

10. A method according to claim 8 wherein the lighting arrangement illuminates the area on the backdrop to a side of the subject in the virtual image with light of an intensity that results in a luminance of the area which is lower than the luminance of the subject in the virtual image.

11. A method according to claim 9 wherein a lighting arrangement illuminates the area of the backdrop to a side of the subject in the virtual image with light emitted at an intensity, wherein the intensity of the light that falls on the backdrop to a side of the subject in the virtual image is altered by moving the lighting arrangement towards or away from the area of the backdrop to a side of the subject in the virtual.

12. A method of producing a Pepper's Ghost, the method comprising projecting an image, comprising a subject illuminated by a light from one or more directions, onto a reflective and transparent screen to create a virtual image of the subject for at least one viewer at a viewing location, and illuminating the object with a light source which at least approximately matches the one or more directions of the light source.

13. A method of producing a Pepper's Ghost, the method comprising projecting an image, comprising a subject illuminated by a light, onto a reflective and transparent screen to create a virtual image of the subject at a location as perceived by at least one viewer, and illuminating an area around the subject with light from a lighting arrangement.

14. A method of producing a Pepper's Ghost, the method comprising projecting an image, comprising a subject illuminated by a light, onto a reflective and transparent screen to create a virtual image of the subject for at least one viewer at a viewing location, and a light source located to be visible to the at least one viewer at the viewing location and appear to the at least one viewer to provide the light present in the image.

15. A method of creating a Pepper's Ghost, the method comprising using a projector to project an image of a subject onto a reflective and transparent screen via a reflective bounce screen to create a virtual image and directing light from a further light source onto the bounce screen to provide desired illumination.

16. A method of producing a Pepper's Ghost, the method comprising projecting an image of a subject onto a reflective and transparent screen to create a virtual image of the subject, and illuminating an area on a floor, on a wall and/or on a backdrop such that the area comprises illumination that appears to be reflected, transmitted and/or produced by the subject in the virtual image.

17. A method according to claim 16 wherein the image of the subject comprises an image of a light source and illuminating the area comprises illuminating the area such that the resultant light on the floor, wall and/or backdrop appears to be a consequence of the light source in the image of the subject.

18. A method according to claim 16 wherein the image comprise areas through which light would be transmitted to create a light pattern if the subject was present and illuminating the area comprises projecting patterns and/or images on the floor, walls and/or backdrop which represent possible patterns and/or images that would be achieved if the subject was actually present and light was transmitted through the subject.

19. A method according to claim 16 wherein the image comprises areas of which light would be reflected to create a light pattern if the subject was present and illuminating the area comprises projecting patterns and/or images on the floor, walls and/or backdrop which represent possible patterns and/or images that would be achieved if the subject was actually present and light was reflected by the subject if the subject was present.

20. A method of producing a Pepper's Ghost, the method comprising projecting an image of a subject onto a reflective and transparent screen to create a virtual image of the subject, and illuminating an area on the floor, on a wall and/or on a backdrop such that the area comprises illumination that appears to create a shadow which the subject in the virtual image would make if the subject was actually present.

21. A method according to claim 20 wherein darker colour light is used to illuminate an area on the floor, wall and/or backdrop to create the shadow.

22. A method according claim 16 wherein the lighting arrangement illuminates the area on the floor, wall and/or backdrop with light of an intensity that results in a luminance of the area which is lower than the luminance of the subject in the virtual image.

23. A method according to claim 16 wherein the lighting arrangement illuminates the area of the floor, wall and/or backdrop with light emitted at an intensity, wherein the intensity of the light that falls on the area is altered by moving the lighting arrangement towards or away from the area whilst maintaining the intensity of light emitted by the lighting arrangement constant.

24. A method of producing a Pepper's Ghost, the method comprising projecting an image of a subject onto a reflective and transparent screen to create a virtual image of the subject and projecting at least one other image onto the reflective and transparent screen to create a virtual image of the at least one other image.

25. A system for producing a Pepper's Ghost, the system comprising a reflective and transparent screen, a projector for projecting an image of a subject onto the reflective and transparent screen to create a virtual image of the subject, and at least one other projector for projecting at least one other image onto the transparent and reflective screen to create a virtual image of the at least one other image.

26. The system according to claim 5 wherein the at least one other image comprises writing relevant to subject in the virtual image.

27. The system according to claim 25 wherein the at least one other image comprises patterns which are relevant to the subject in the virtual image

28. A method of creating a Pepper's Ghost, the method comprising using a projector to project an image of a subject onto a reflective and transparent screen via a reflective bounce screen to create a virtual image of the subject and altering a distance between the projector and the reflective bounce screen to move the virtual image.

29. A system for producing a Pepper's Ghost, the system comprising a transparent and reflective screen, a reflective bounce screen, a projector for projecting an image of a subject onto the reflective and transparent screen via the reflective bounce screen to create a virtual image of the subject, wherein the reflective bounce screen is movable such that a distance between the projector and reflective bounce screen can be altered to alter the alter the position of the virtual image of the subject.

30. A system for producing a Pepper's Ghost substantially as described hereinbefore with reference to the accompanying drawings.

31. A system for producing a Pepper's Ghost, the system comprising a transparent and reflective screen, a reflective bounce screen, a projector for projecting an image of a subject onto the reflective and transparent screen via the reflective bounce screen to create a virtual image of the subject and a further light source for directing light onto the bounce screen.
